(19) United States
(12) Patent Application Publication
(10) Pub. No.: US 2016/0096397 A1
(43) Pub. Date: Apr. 7, 2016

(54) Thermochromic Bathtub Shower Sheet Toy

(71) Applicant: Paul C. Wakefield, Lehigh Acres, FL (US)

(72) Inventor: Paul C. Wakefield, Lehigh Acres, FL (US)

(21) Appl. No.: 14/506,784

(22) Filed: Oct. 6, 2014

(51) Int. Cl. B44F 1/10

(52) U.S. Cl. CPC B44F 1/10

(57) ABSTRACT

Thermochromic Bathtub Shower Sheet Toy invention is laminated sheets with enclosed thermochromic illustrations which are placed in a shower/bath tub. The invention has an illustrated printed insert, which illustrations are covered by opaque thermochromic ink. That thermochromic ink clarifies as a temperature of about 75 degrees F. As the child splashes warm bath water on the laminated illustration, the thermochromic ink covering clarifies, and the entertaining illustration is revealed. This entertains and educates the child receiving the bath.

This invention claims priority to provisional application 61/855,888 filed 28 May 2013

### FIELD OF INVENTION

The invention is concerned with laminated thermochromic illustrations. In particular, the invention is concerned with laminated and encapsulated thermochromic ink covered illustrations that are placed in a shower/bath tub. As the child splashes warm bath water on the laminated illustration, the thermochromic ink covering clarifies, and the entertaining illustration is revealed. This entertains and educates the child receiving the bath.

### BACKGROUND OF INVENTION

Thermochromic inks are organic inks that change color from a first color to a second color. The thermochromics inks of the present invention are water soluble microencapsulated slurries of thermochromic ink. For example, Matsui thermochromic ink type 27 changes color at 75° F. (Type 27 by definition starts to change color at 27° Celsius or 75° Fahrenheit) is a certain color at 70° Fahrenheit and a second color at 80° Fahrenheit. The color change is dependent upon the ambient temperature. While Matsui type 27 is the preferred thermochromic ink, Masui types 17, 18, and 25 are useful especially if they are coated in more than one coating. Thermochromic inks and the processes of creating thermochromic illustrations have been well-known and widely used for some decades. As such they are well known both to the patent and commercial arts. Matsui thermochromic AQ type 27 is a standard formulation that has been available for decades from Matsui chemical. It is a proprietary formula. Likewise, Matsui Chromicolor UV type 27 is useful. AQ in Matsui formulation means it is water soluble. UV means it is activated by ultraviolet light.

The dark or opaque thermochromic ink of the present invention becomes clear at higher temperatures revealing an illustration underneath the thermochromic coating that was opaque at the lower temperature. The “magic” unveiling of the formerly covered illustration delight and entertain the child receiving the bath.

The instant invention is concerned with two common arts. The first concern is safety for small children as they are bathed or showered. These children are currently provided with bath toys such as floating objects including ducks, boats, and water based crayons. Often these toys have small parts and provide a hazardous choking warning for small children. The instant invention is flat laminated thermochromic sheets. Useful sizes for the product are 8.5×11, 8.5×14, 11×17, and 23×35 inches. This toy is sold under the name “Magic Bath Poster™.” “Magic Bath Poster™” is completely safe for children of any age and does not have or require a consumer safety warning because is a flat sheet. Laminated thermochromic sheets have an external clear plastic covering on front and obverse to enclose the thermochromic illustration. Laminations extend 0.25 inches beyond the edge the printed product providing encapsulation and prevent any water from penetrating to the enclosed thermochromic illustration.

A second element of the invention is a thermochromic ink applied to the illustration. The thermochromic ink appears or disappears (changes colors) in response to changes in temperature. As warm water is splashed on the thermochromic illustration, that thermochromic opacity will become clarified revealing the illustration beneath.

One embodiment of Magic Bath Poster™ has a few images i.e. letters, shapes, animals, and such not covered with the thermal chromic ink. These letters shapes, animals, and such not covered with the thermochromic ink mask infers that something is hidden and encourages the child to solve the mystery. The obverse or static side is printed with different coloring images that can be colored in the bath with bath tub crayons or when dry with erasable markers.

The process of producing the invention is essentially simple. Images are printed on the paper and thermochromic ink is screened over the printed images on the front to mask/hide images that are revealed. The desired characteristics of the thermochromic ink include the specific color desired and a specific temperature at which the color changes. Examples of patents that describe thermochromic ink and processes include U.S. Pat. Nos. 6,416,853, 7,985,701.

### SUMMARY OF THE INVENTION

The process of production of the present invention includes the following materials and processing steps. First, the base non-thermochromic images on the front and obverse of the insert are printed on paper using either offset and/or digital imaging. In a non-preferred embodiment printing on the obverse can be omitted. In a second non-preferred embodiment both the front and obvers side may be coated with the revealing thermochromic ink to cover the underlying illustrations. In a third non-preferred embodiment two or more thermochromic inks with different revealing temperatures such as Matsui types 17, 18, and 25 may be used to cover the illustration. As the color gradually changes the underlying illustrations are revealed gradually.

Second, the covering mask of thermochromic ink is silk screen printed with the desired color. These thermochromic inks have color change at useful temperatures for children's baths. Second, the chosen illustration should be printed on 80 to 100 Lb or cover ultra-bright with matte finish on both sides.

Offset printing is optimally used and requires a minimum of 350 dpi for the illustration to be useful. Digital print may also be used to print the obverse or bottom image providing the toner or inkjet provides good adhesion to both the front and obverse of the insert. Standard print type and binder/thermochromic coating combinations are chosen from common patent and commercial art.

After the desired illustrations are printed on the both sides of the insert, the thermochromic coating mix is screen applied to the illustration. A coating mix for the thermochromic ink is approximately 50%±clear binder and 50%±type 27 thermochromic coating. The particular ratio of binder to thermochromic coating reflects the ratio of coating that is optimal for the particular coating equipment. This equipment is a semi-automatic press or hand pull produced by screening on a flatbed press. The art of producing useful thermochromic printing requires adequate masking and coverage. This masking and coverage should be kept at an optimal minimum because the inks have opacity as the color has changed or disappeared.

This silk screen is optimally eighty mesh or higher. An option of the present invention is to screen two or more coats because two light coats are better than one heavy coat. There are two types of ink. Each requires a separate printing process. When using water based thermochromic ink coating, individual paper is screened one sheet at a time by placing on the flatbed printer or hand screening one sheet at a time. Sheets are then taken to an air rack left to dry for approximately 30 minutes. If required the racked sheets are rescreened with the second coat and placed to dry for 30 minutes. After the run of sheets are completely screened they are more completely dried with a standard belt dryer at low heat and medium speed to ensure that they are fully dry prior to being laminated. When using UV cure thermochromic ink, the coating the process is essentially the same except that each sheet is immediately placed through a UV light dryer on optimal setting to cure that print pass. Then the processed piece is stacked and the coating and UV drying process repeated. Then the sheets are completely dried with a standard belt dryer at low heat and medium speed to ensure that the moisture is removed from the sheet prior to laminating. Optimally a 1.7 or 5 mil gloss, UV protective laminate sheet is used. UV blocking sheets protect thermochromic coating and the 1.7 or 5 mil is strong, durable and lightweight. That grade of laminate sheeting has good heat transfer with maximum protection of the illustration.

Front and obverse plastic sheets are bound by heat with a minimum ¼ inch border around the periphery so that the illustrations have a complete waterproof encapsulation. The final step is to round corners to ensure the child is not injured on a sharp corner. Useful sizes for the product are 8.5×11, 8.5×14, 11×17, and 23×35 inches. The product can be printed on one or both sides of the paper.

In use, the laminated thermochromic illustrations are attached to the back/inside wall of the tub or tile wall surface above the tub. The child splashes water on the illustration inducing the thermochromic ink to clarify which clarification amuses the child. Since the wall quickly absorbs heat, the original colors quickly return causing the child to re-splash, repeating the cycle.

### BRIEF DESCRIPTION OF INVENTION

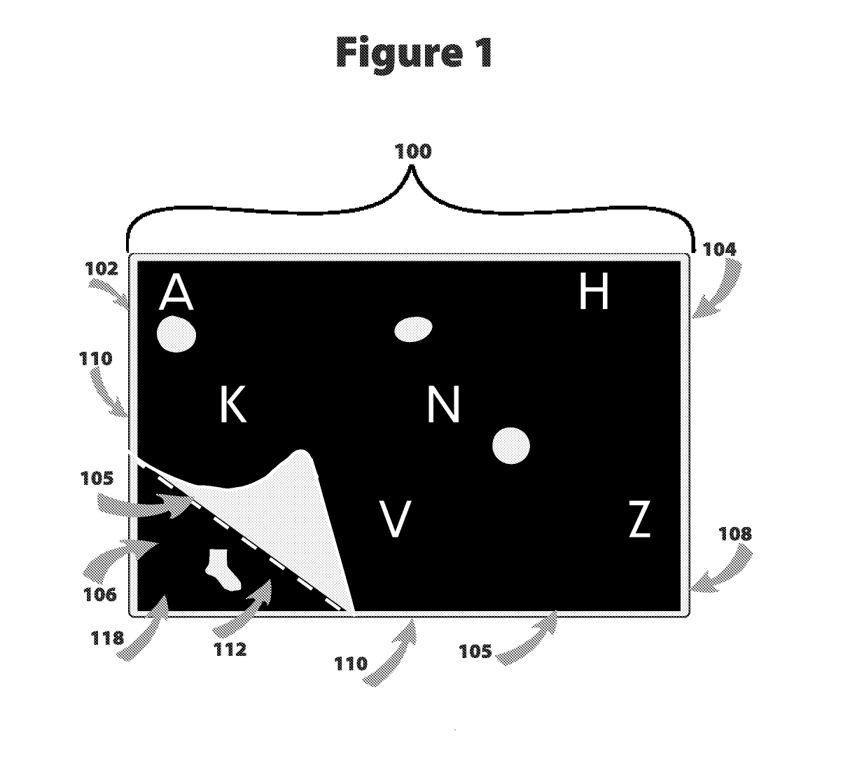

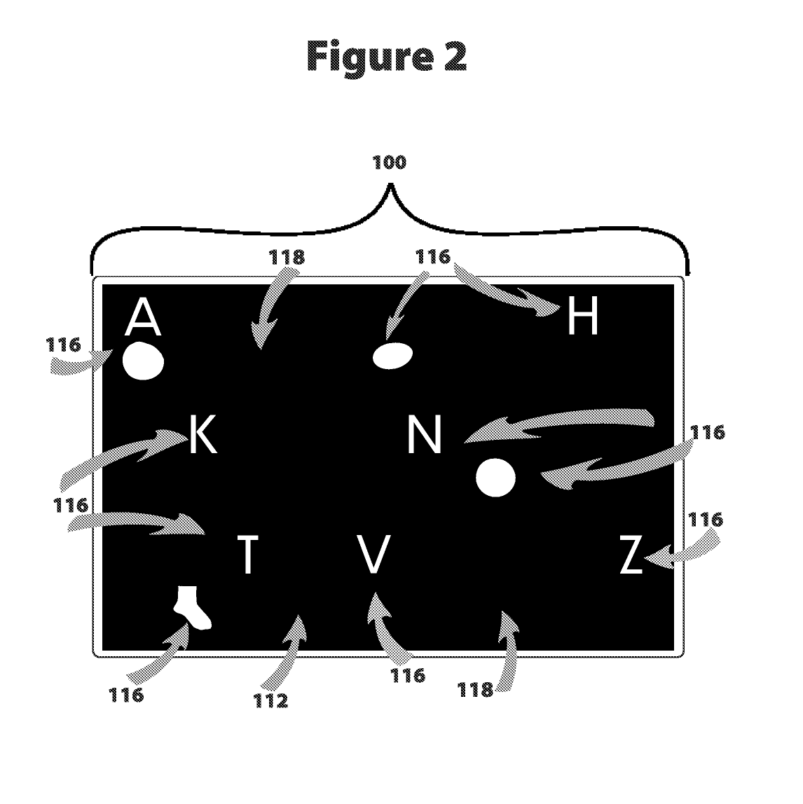

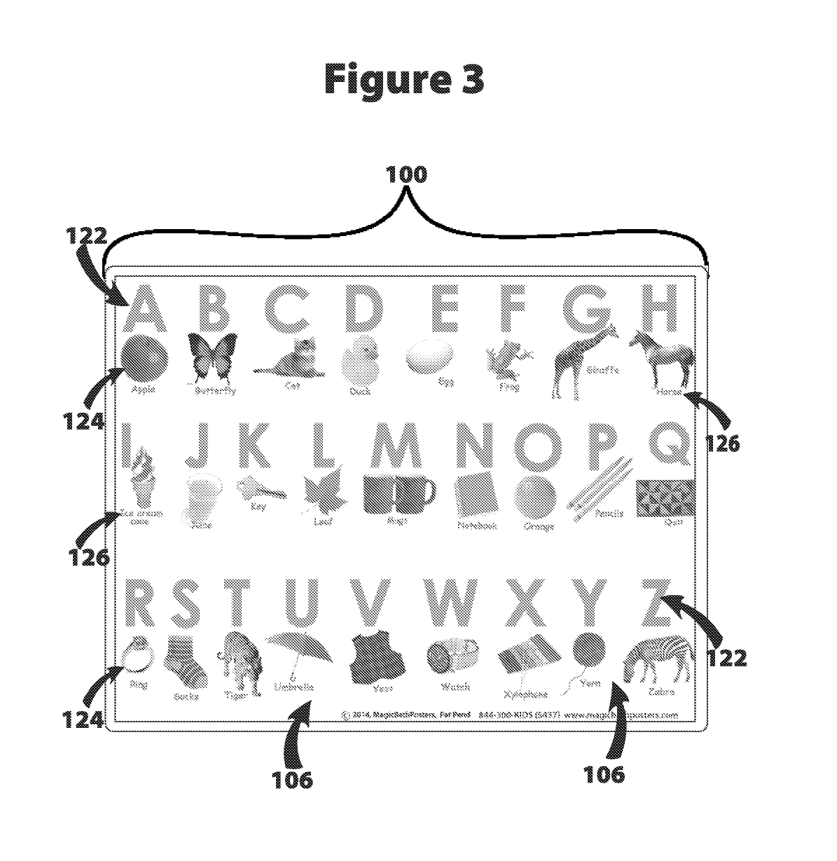

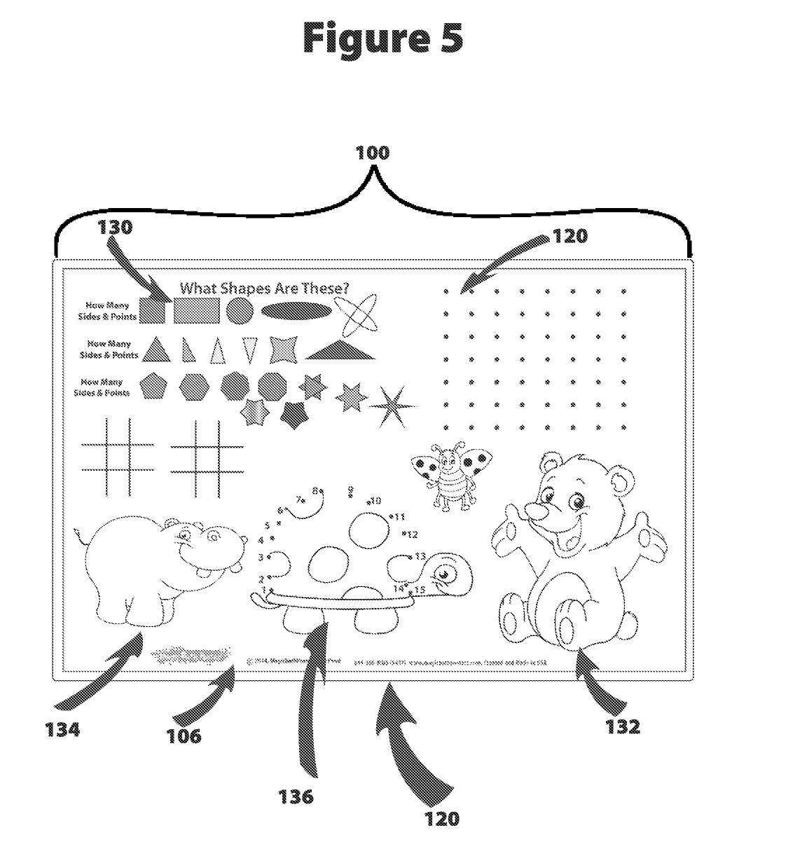

FIG. 1 shows a preferred embodiment of the invention 100 with front clear sheet 102 and obverse clear sheet 104 (not shown). FIG. 2 shows the insert front 118 of the preferred invention 100 covered with thermochromic ink 112. FIG. 3 shows the front of the flat insert 106 of the invention 100 without thermochromic ink covering 112. FIG. 5 show the obverse side 120 of the insert 106 of FIG. 2. This obverse side 120 shows activities and illustrations that amuse and educate the child.

### DETAILED DESCRIPTION OF INVENTION

FIG. 1 shows a preferred embodiment of the invention 100 with front clear sheet 102 and obverse clear sheet 104 (not shown). Front sheet 102 is opened 105 to reveal the thermochromic ink covered insert 106. Front sheet 102 and obverse sheet 104 are affixed together 108 along the periphery 110. Insert front 118 is covered with an opaque thermochromic ink 112 which ink is applied using a silkscreen printing.

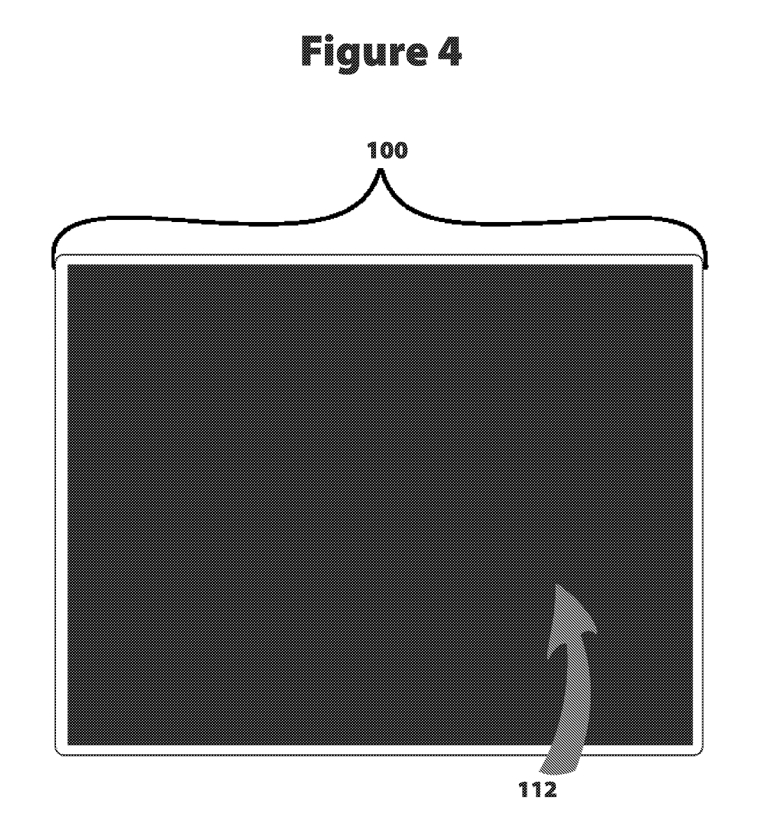

FIG. 2 shows the insert front 118 of the preferred invention 100 covered with thermochromic ink 112. In this embodiment the thermochromic ink covering 112 has openings 116. These openings 116 reveal some of the letters and figures of the front insert as shown in FIG. 3. The openings are not covered with thermochromic ink 112. FIG. 4 show a second embodiment of the invention 102 with the entire front of insert front 118 is covered by thermochromic ink 112.

FIG. 3 shows the front of the flat insert 106 of the invention 100 without thermochromic ink covering 112. It shows the alphabet letters, A-Z, 122 each with a picture 124 under the letter to show an example of things with spelling 126 whose first letter is that of the shown letter. Thus below A is a picture of an apple and the spelling of apple, below B is a picture of a butterfly and the spelling of butterfly, and so forth. However, the invention is not limited by this preferred example of the alphabet. Any number of different illustrations of interest to small children could be used. The letter illustrations of the insert are printed by standard printing means. Because the thermochromic ink of the present invention clarifies with warm water over 27° C., warm water will reveal the complete illustrations as shown in FIG. 3.

FIG. 4 show a second embodiment of the invention 100. In this embodiment the entire front of insert front 118 is covered by thermochromic ink 112. This embodiment is similar to the preferred embodiment of FIG. 2 except there is no teasing illustrations.

FIG. 5 show the obverse side 120 of the insert 106 of FIG. 2. This obverse side 120 shows activities and illustrations that amuse and educate the child. Includes are shapes of different colors 130 (colors not shown), cartoon animals such as a teddy bear 132, or hippopotamus 134. Likewise, the clear plastic sheets can be used with erasable crayons to connect the dots of a turtle 136 as shown. Note as in the covered side of the sheet any number of illustrations including colorable illustrations other than these preferred illustration could be used to amuse and educate the child. In the preferred embodiment illustrations on one side is covered with opaque thermochromic ink. In fact both sides could be covered opaque thermochromic ink.

1. I claim:
a thermochromic bathtub shower sheet toy comprising;
a flat insert with a printed front side and a printed obverse side;
at least one side of said insert is covered with water soluble microencapsulated slurries of thermochromic ink;
said thermochromic ink is opaque below temperature of 74° Fahrenheit, or 27° Celsius and clear at temperature of 91° Fahrenheit or 33° Celsius);
said flat insert is enclosed by a front clear sheet and obverse clear sheet;
said front sheet and said obverse sheet are affixed together along their periphery.

2. A thermochromic bathtub shower sheet toy as in claim 1 wherein said printed front
has printed alphabet letters with figures to show the first letter for the respective letter of the alphabet and spelling for that figure.

3. A thermochromic bathtub shower sheet toy as in claim 1 wherein said observe side
shows activities and colorable illustrations.

4. A thermochromic bathtub shower sheet toy as in claim 1 wherein said thermochromic ink
is Matsui Chromicolor AQ type 27 or Matsui Chromicolor UV type 27.

5. A thermochromic bathtub shower sheet toy as in claim 1 wherein said thermochromic ink
in its opaque state is the color black.

6. A thermochromic bathtub shower sheet toy as in claim 1 wherein said front clear sheet
and obverse clear sheet are UV blocking sheets.

7. A thermochromic bathtub shower sheet toy as in claim 1 wherein said front sheet and said obverse sheet affixed together along their periphery have rounded corners.

8. A thermochromic bathtub shower sheet toy as in claim 1 wherein said insert is printed
only on the front side.

9. A thermochromic bathtub shower sheet toy comprising;
a flat insert with a printed front side and plain obverse side;
said front side of said insert is covered with thermochromic ink Matsui AQ thermochromic ink type 27;
said thermochromic ink is opaque below temperature of 74° Fahrenheit, or 27° Celsius and clear at temperature of 91° Fahrenheit or 33° Celsius;
said flat insert is enclosed by a front clear sheet and obverse clear sheet;
said front sheet and said obverse sheet are affixed together along their periphery.
